(19) United States
(12) Patent Application Publication
(10) Pub. No.: US 2008/0240794 A1
(43) Pub. Date: Oct. 2, 2008

(54) Printing machine incorporating plastic metering roller

(75) Inventor: Nathan John Prior, Oaklands Park (AU)

Correspondence Address: KLAUBER & JACKSON, 411 HACKENSACK AVENUE, HACKENSACK, NJ, 07601, US

(73) Assignee: Research Laboratories of Australia Pty Ltd

(21) Appl. No.: 12/079,182

(22) Filed: Mar. 25, 2008

(30) Foreign Application Priority Data
Mar. 26, 2007 (AU) 2007901589

(51) Int. Cl. G03G 15/09

(52) U.S. Cl. 399/274

(57) ABSTRACT

A metering roller for a printing machine utilising a high viscosity ink. The metering roller has an axle, a cylindrical roller body formed on the axle and an annular surface layer. The annular surface layer has a surface of a low surface energy and a pattern of a plurality of ink receiving recesses formed in the annular surface layer. The annular surface layer can be integral with the cylindrical roller body or separate from it and can be a plastic material. The annular surface layer has a surface energy in the range of from 18 to 46 dynes/cm.

### RELATED APPLICATION

The present application claims priority under 35 U.S.C. 119(a)-(d) from Australian Application No. 2007901589, filed Mar. 26, 2007, and the disclosure of said application is incorporated herein by reference in its entirety.

### BACKGROUND OF THE INVENTION

1. Field of Invention

This invention relates to printing machines and more particularly but not restricted to electrostatic type printing machines.

2. Description of the Related Art

Impact printing machines have for many years used metering rollers to meter the amount of ink applied to an inking roller or roller train. One such type of metering roller is known as an Anilox roller and comprises in general a metal roller with a cylindrical surface with a very fine pattern etched or machined into the surface. In use, the ink is applied to a metering roller and then a doctor blade scrapes off ink other than where it is within the recesses of the recess pattern on the surface of the metering roller. The metering roller is then run onto an inking roller and a very fine layer of the ink is transferred to the inking roller from the recesses.

Electrostatography can be a term used to describe the various non-impact printing processes which involve the creation of a visible image by the attraction of charged imaging particles or marking particles to charged sites present on a substrate. Such charged sites, forming what is usually termed a latent image, can be transiently supported on photoconductors or pure dielectrics and may be rendered visible in situ or be transferred to another substrate to be developed in that location.

It is known that latent electrostatic images can be developed with marking particles dispersed in insulating or non-polar liquids. Such marking particles normally comprise colouring matter such as pigments which have been ground with or otherwise combined with resins or varnishes or the like. Additionally, charge directing agents are usually included to control the polarity and charge-to-mass ratio of the toner particles. These dispersed materials are known as liquid toners or liquid developers. In use, a liquid developer is applied to the surface of a latent image bearing member to develop an electrostatic image on the member.

Highly concentrated liquid toner development systems utilising toner with solids concentrations of up to 60% by weight and viscosities of up to 10,000 mPa·s, and utilizing thin films, typically 1 to 40 μm, of the highly concentrated and viscous liquid toner have been disclosed. The system of developing electrostatic latent images with these viscous and highly concentrated liquid toner systems have been termed high viscosity toner or HVT systems. Examples of such liquid toners are disclosed in commonly assigned U.S. Pat. No. 5,612,162 to Lawson et al., and U.S. Pat. No. 6,287,741 to Marko, the disclosures of which are totally incorporated herein by reference. Examples of high viscosity, high concentration liquid developing methods and apparatus are disclosed in commonly assigned U.S. Pat. No. 6,137,976 to Itaya et al., U.S. Pat. No. 6,167,225 to Sasaki et al., and PCT publication WO 2007/028205 the disclosures of which are totally incorporated herein by reference.

In the case of electrostatic printing machines the inking roller is the development roller.

Anilox rollers in general are expensive to manufacture and it can be difficult to ensure that all ink or toner from an Anilox roller is transferred to an inking roller or a development roller.

It is the object of this invention to provide a metering roller for a printing machine and more particularly for an electrostatic printing machine which is inexpensive to manufacture and has improved toner transfer characteristics.

### SUMMARY OF THE INVENTION

In one form therefore the invention is said to reside in a metering roller for a printing machine utilising a high viscosity ink, the metering roller comprising an axle and a cylindrical roller body formed on the axle, the cylindrical roller body comprising an annular surface layer, the annular surface layer having a surface of a low surface energy and a pattern formed in the annular surface layer, the pattern comprising a plurality of ink receiving recesses.

Preferably the annular surface layer has a surface energy in the range of from 18 to 46 dynes/cm.

Preferably the annular surface layer comprises a plastic material. The word “plastic” as used herein is interchangeable with and analogous in meaning to the words polymer and resin. More preferably the cylindrical roller body and the annular surface layer comprise a plastic material. Both the cylindrical roller body and the annular surface layer can comprise the same plastic material or they can comprise different plastic materials.

In one embodiment the cylindrical roller body and surface layer are integral and comprise an overall diameter of from 15 mm to 100 mm and a length of from 100 mm to 2 m. Alternatively the cylindrical roller body comprises a diameter of from 11 mm to 80 mm and the annular surface layer comprises a thickness of from 2 mm to 10 mm and the cylindrical roller body comprises a length of from 100 mm to 2 m.

Alternatively, the cylindrical roller body can comprise metal and the annular surface layer comprises a plastic material and in such an embodiment the annular surface layer can comprise a thickness of from 2 mm to 10 mm.

The pattern of the plurality of ink receiving recesses can be selected from the group comprising a random pattern, tri-helical, Z-channel or other pattern as known in the art and having a line resolution of from 100 to 300 lines per inch and a pattern depth of from 5 to 100 μm or more preferably a trihelical surface pattern configuration, a resolution of 200 lines per inch and a pattern depth of 30 μm.

The plastic material can be selected from the group comprising polypropylene, polymethylpentene (for instance TPX® a 4-methylpentene-1 based polyolefin), polytetrafluoroethylene (PTFE; for instance Teflon®), polystyrene, acetal and nylon. Polymethylpentene for instance has a surface energy of approximately 24 dynes/cm, polypropylene has a surface energy of approximately 29 dynes/cm, PTFE has a surface energy of approximately 18 dynes/cm, polystyrene has a surface energy of approximately 34 dynes/cm, acetal has a surface energy of approximately 36 dynes/cm and nylon has a surface energy of approximately 46 dynes/cm. The plastic material can be insulative or electrically conductive.

The word “ink” as used herein is interchangeable with and analogous in meaning to the words toner, liquid toner, developer or liquid developer.

Wetting is the contact between a fluid and a surface, when the two are brought into contact. When a liquid has a high surface tension (strong internal bonds), it will form a droplet, whereas a liquid with low surface tension will spread out over a greater area (bonding to the surface). On the other hand, if a surface has a high surface energy (or surface tension), a drop will spread, or wet, the surface. If the surface has a low surface energy, a droplet will form. This phenomenon is a result of the minimization of interfacial energy. If the surface is high energy, it will want to be covered with a liquid because this interface will lower its energy.

Hence, in the present invention the ink of a low surface energy will not wet the surface of the roller with a low surface energy as much as it would wet a metal surface of high surface energy and hence the energy required to remove the ink from the surface will be less. It will be seen that by this invention that a surface is provided on the metering roller which is of a relatively low surface energy thereby discouraging wetting of the surface of the metering roller by the ink and requiring less energy to remove the ink at the stage of transfer to the inking roller or development roller.

The pattern of a plurality of ink receiving recesses can have a profile selected from the group comprising semicircular, triangular, trapezoidal, or other profile as known in the art, more preferably a trapezoidal profile and a pattern selected from the group comprising a random pattern, a trihelical, Z-channel or other pattern as known in the art and having a line resolution of from 100 to 300 lines per inch and a pattern depth of from 5 to 100 μm or more preferably a trihelical surface pattern configuration, a resolution of 200 lines per inch and a pattern depth of 32 μm.

In an alternative form the invention is said to reside in a printing machine including a high viscosity ink supply mechanism to supply a high viscosity ink to a printing mechanism, the ink supply mechanism including a metering roller, the metering roller comprising an axle, a cylindrical roller body formed on the axle and an annular surface layer on the cylindrical roller body, the annular surface layer having a surface of a low surface energy substantially similar to the surface energy of the high viscosity ink and a pattern formed in the annular surface layer, the pattern comprising a plurality of ink receiving recesses.

In an alternative form the invention is said to reside in a printing machine including a high viscosity ink supply mechanism to supply a high viscosity ink to a printing mechanism, the ink supply mechanism including a metering roller, the metering roller comprising an axle and a cylindrical roller body formed on the axle, the cylindrical roller body comprising a first plastic material and the cylindrical roller body comprising an annular surface layer of a second plastic material and a pattern formed in the annular surface layer, the pattern comprising a plurality of ink receiving recesses.

The printing machine can be an electrostatographic printing machine and the high viscosity ink comprises a high viscosity toner comprising a concentration of insoluble chargeable particles of up to 60% by weight in a non-conductive carrier liquid.

In an alternative form the invention is said to reside in a metering roller for a high viscosity ink supply mechanism, the metering roller comprising an axle and a cylindrical roller body formed on the axle and an annular surface on the cylindrical roller body, the cylindrical roller body comprising a plastic material selected from the group comprising polypropylene, polymethylpentene, polytetrafluoroethylene, polystyrene, acetal and nylon and a pattern formed in the annular surface, the pattern comprising a plurality of ink receiving trapezoidal recesses in a trihelical surface pattern configuration comprising a resolution of 200 lines per inch and a pattern depth of 30 μm and the cylindrical roller body comprising an overall diameter of from 15 mm to 100 mm and a length of from 100 mm to 2 m.

In an alternative form the invention is said to reside in an electrostatic printing machine for high speed printing comprising;

(a) a toner supply device to supply to a toner supply roller a high viscosity highly concentrated toner;
(b) a metering roller which receives a thin layer of the toner from the toner supply roller;
(c) a development member;
(d) the metering roller bearing against the development member with an interference fit to transfer a thin layer of the toner onto the development member;
(e) an image forming stage, the image forming stage comprising an image carrying member having a surface adapted to retain an electrostatic latent image thereon;
(f) the development member engaging against the image carrying member with an interference fit to give a selected contact time therebetween;
(g) a development stage in which toner particles in the thin layer on the development member are transferred to the image carrying member under the influence of the electrostatic latent image on the image carrying member to provide a developed image thereon; and
(h) a transfer stage in which the developed image is transferred from the image carrying member onto a substrate,
wherein the metering roller comprises an axle and a cylindrical roller body formed on the axle, the cylindrical roller body comprising an annular surface layer, the annular surface layer having a surface of a low surface energy formed from a plastic material and a pattern formed in the annular surface layer, the pattern comprising a plurality of ink receiving recesses.

There can be further included a doctor blade bearing against the metering roller.

This then generally describes the invention but to assist with understanding reference will now be made to the accompanying drawings which show preferred embodiment of the invention.

### BRIEF DESCRIPTION OF THE DRAWINGS

FIG. 1 shows a schematic view of an electrostatic printing machine incorporating at metering roller according to the present invention;

FIG. 2 shows a perspective view of a metering roller according to one embodiment to the present invention;

FIG. 3 shows a cross-sectional view of one embodiment of metering roller according to the present invention;

FIG. 4 shows an alternative embodiment of metering roller according to the present invention;

FIGS. 5A to 5C show various embodiments of surface profile useful for the present invention, and

FIGS. 6A and 6B show various surface patterns.

### DETAILED DESCRIPTION OF THE INVENTION

The present systems for developing electrostatic latent images with viscous and highly concentrated liquid toner systems are able to achieve high print image density, no background staining or fog, and highly resolved images, that are usually associated with analogue printing methods such as offset and gravure printing. At high print speeds however, processing parameters and development times become critical and special constructions and operational techniques are necessary for good imaging. One of the critically important parameters to be controlled is that of ink or toner film thickness, and the metering or Anilox roller construction and characteristics are a key factor in being able to consistently maintain a stable toner layer over a large surface area for long print runs.

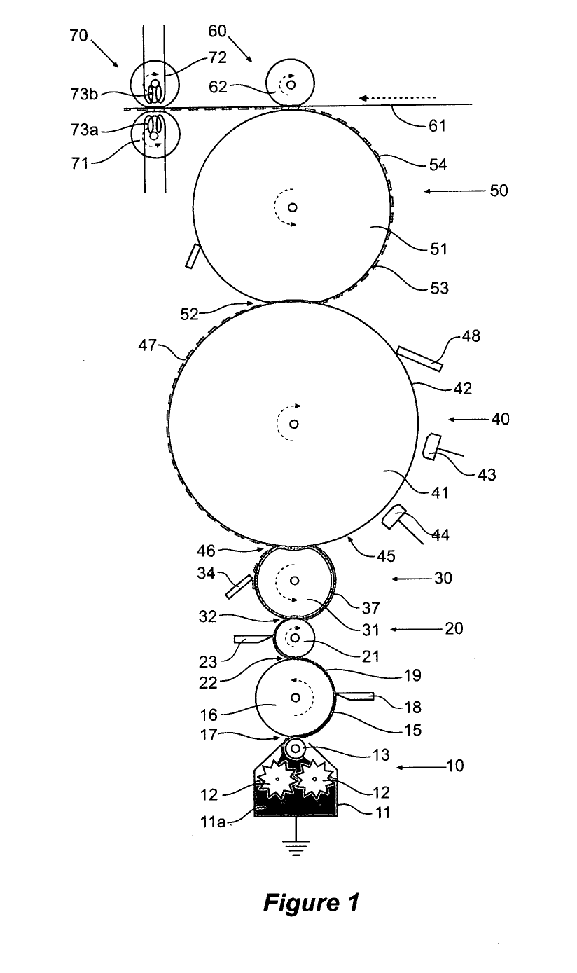

Now looking at FIG. 1, this drawing shows a schematic electrostatic printing apparatus according to the present invention and particularly shows the position of a metering roller according to the present invention.

In FIG. 1, the schematic electrostatic printing process generally has a toner supply stage 10, a toner metering apparatus 20, a development stage 30, an imaging stage 40, an intermediate transfer stage 50, a transfer to substrate stage 60 and a fixing stage 70.

In the toner supply stage 10 a toner tank 11 has counter rotating gear wheels 12 which extend into toner 11a in the tank 11 and provide a supply of high viscosity toner to a supply roller 13. The supply roller extends out of the top of the toner tank 11 and is spaced apart from a pick-up roller 16 by a gap 17 which is in the range of from 100 to 500 μm. This produces a layer of toner on the pick-up roller of at least 100 μm. The toner supply stage may comprise other forms or methods of supplying, pumping or otherwise moving the toner from toner tank 11 to pick-up roller 16.

The pick-up roller 16 has a doctor blade 18 bearing against it to provide an even thin layer of high viscosity toner on the pick-up roller 16.

The pick-up roller 16 is spaced apart from a metering roller 21 by a gap 22 which can be in the range of from 50 to 400 μm. The metering roller 21 has a pattern of recesses on its surface and a doctor blade 23 bearing against the metering roller 21 scrapes essentially all of the high viscosity toner off the metering roller 21 except that toner which is within the recesses in the pattern of recesses on the metering roller 21. The metering roller 21 has at least a surface layer formed from a plastic material and the doctor blade 23 bearing against the metering roller 21 is formed from a material selected from elastomeric material and a plastics material.

In one preferred embodiment the metering roller preferably has a trihelical pattern of recesses with a resolution of 200 lines per inch with a normal pattern depth of 32 μm.

The metering roller 21 bears against a development member 31 with an interference fit 32 which is within the range of 50 to 2000 μm. The interference fit is made possible because although the surface of the metering roller 21 is relatively hard, the surface of the development member 31 is relatively soft and the metering roller 21 pushes into the development member 31. The interference fit provides a contact time during the rotation of each roller during which toner may be transferred from the metering roller 21 to the development member 31. The thickness of toner on the development member 31 after it has been transferred from the metering roller 21 is in the range of from 1 to 40 μm.

A cleaner device 34 acts against the development member 31 to clean toner off the developing roller after the development stage as discussed below.

The imaging carrying member in the imaging stage 40 is an imaging roller 41 which has a surface 42 which will carry an electrostatic charge thereon. A charging device 43 provides an even electrostatic charge on the surface 42 of the imaging roller 41 and then a selective discharge device 44 discharges the electrostatic charge so that the surface 42 then has an electrostatic image thereon in the region generally shown as 45. The image carrying member can have a surface 42 which is a dielectric in which case the charging device 43 is a corona discharge device, a charging roller or the like, and the selective discharge device 44 may be an ion gun, for instance. Alternatively, the image carrying member may have a surface 42 which is a photoconductor in which case the charging device 43 is a corona discharge device, a charging roller or the like, and the selective discharge device 44 may be a laser or LED device, for instance. Alternatively, the image carrying member may have a surface 42 which is a permanently polarised material as in the case with ferroelectrics or other electrets.

The development member 31 bears against the imaging roller 41 with an interference fit 46 which may be in the range of 50 to 2000 μm.

The imaging roller 41 has a relatively hard surface and the development member 31 has a relatively soft surface so that the imaging roller pushes slightly into the development member 31. This gives an interference fit and hence a residence or increased contact time between the rollers during which time the electrostatic image is developed by marking particles in the thin layer of toner being attracted to the electrostatic image to give a developed toner image.

Alternatively, the image carrying member may be an imaging belt, which has a surface that carries an electrostatic charge thereon. In this configuration, the imaging belt is held against the development member and the intermediate transfer roller by means of two pressure rollers which engage against the rear side of the imaging belt at the respective contact regions.

The developed toner image 47 is then carried around on the surface 42 of the imaging roller 41 until the intermediate transfer roller 51 is reached. The intermediate transfer roller 51 engages against the imaging roller 41 with an interference fit 52. Again, the interference fit between the imaging roller 41 and the intermediate transfer roller 51 provides a contact time in which toner particles of the developed toner image are transferred to the intermediate transfer roller 51 under the influence of an electric field. The interference fit of the imaging roller against the intermediate transfer roller 51 may be from 50 to 2000 μm. The developed toner image on the surface 42 of the imaging roller 41 is hence transferred to the surface 53 of the intermediate transfer roller 51 and carried around to the final transfer stage 60.

After the developed toner image on the surface 42 of the imaging roller 41 has been transferred to the intermediate transfer roller 51 a cleaner arrangement 48 shown schematically is used to remove excess toner from the imaging roller before it is recharged.

In the final transfer stage 60, the developed toner image is transferred from the intermediate transfer roller 51 to a substrate 61 which is held against the intermediate transfer member 51 by means of a pressure roller 62 which engages against the rear side of the substrate 61. It should be understood that transfer may be of the electrostatic type, pressure type, transfix type, combinations thereof, or other known methods and techniques of transferring and fusing toner images. The substrate 61 may be a continuous web or individuals sheets of paper or other material.

After the developed toner image has been transferred to the substrate 61, it is carried on the substrate and additionally, if required, the substrate passes between a pair of heated rollers 71 and 72 in the fixing stage 70, and the toner is fixed permanently onto the substrate. The heated rollers 71 and 72 have heater elements 73a and 73b to provide heat to fix the toner onto the substrate.

The toner travel path for this embodiment of the invention is shown on FIG. 1 by means of a shaded line. The gear wheels 12 feed toner from the tank 11 to the supply roller 13 upon which it is carried to the pick-up roller 16 and then carried on the pick-up roller 16 in an anti-clockwise direction past doctor blade 18 until it reaches the metering roller 21. It is then transferred to the metering roller 21 which rotates in a clockwise direction and the doctor blade 23 on the metering roller 21 again reduces the thickness of toner. The toner is carried in a clockwise direction on the metering roller 21 to the development member 31 where it transfers to the development member during the residence time provided by the interference fit between the metering roller and the development member, as discussed above, to give a thin layer of liquid toner on the development member 31.

The thin layer of liquid toner is then carried in an anti-clockwise direction on the development member past the carrier liquid displacement corona 33, as discussed earlier, until it reaches the imaging roller 41. At this stage, some of the toner particles are transferred in an image-wise manner to the imaging roller 41, but not all is transferred and hence, some toner continues on around the development member 31 to the cleaner 34. The transferred toner 47 is carried in a clockwise direction around the imaging roller 41 past the carrier liquid displacement corona 33a, as discussed earlier, to the intermediate transfer roller 51 where the toner 54 is transferred to the intermediate transfer roller 51 and is carried in an anti-clockwise direction on the intermediate transfer roller 51 until it reaches the substrate 61. The toner is then transferred to the substrate 61 and proceeds to the fixing station 70 as discussed above.

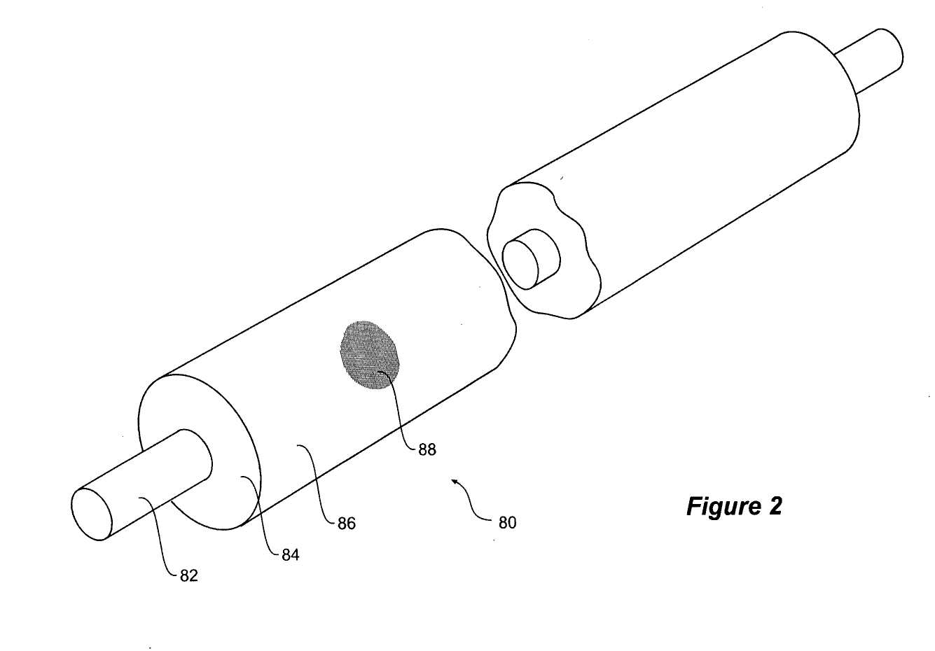

FIG. 2 shows a perspective view of one embodiment of a metering roller according to the present invention.

In this embodiment the metering roller 80 includes a steel or stainless steel axle 82 upon which is formed a cylindrical roller body 84. On the surface layer 86 of the cylindrical roller body 84 a pattern of recesses 88 is formed to act as ink retaining recesses.

The pattern of recesses 88 may be formed by a number of different methods. One method is to mechanically knurl the rollers. They are created from a blank and the pattern is forced into the surface by a knurling tool. An alternative method may be by chemical etching. This is a method where a mask is applied to the roller surface and then an aggressive chemical is allowed to etch the pattern out. Another method is to laser engrave the pattern. The best results to date have been with injection moulding. This method is a very cost effective method as the pattern is applied in the injection moulding tool and the pattern is formed at the injection moulding stage without the necessity of subsequent working of the metering roller.

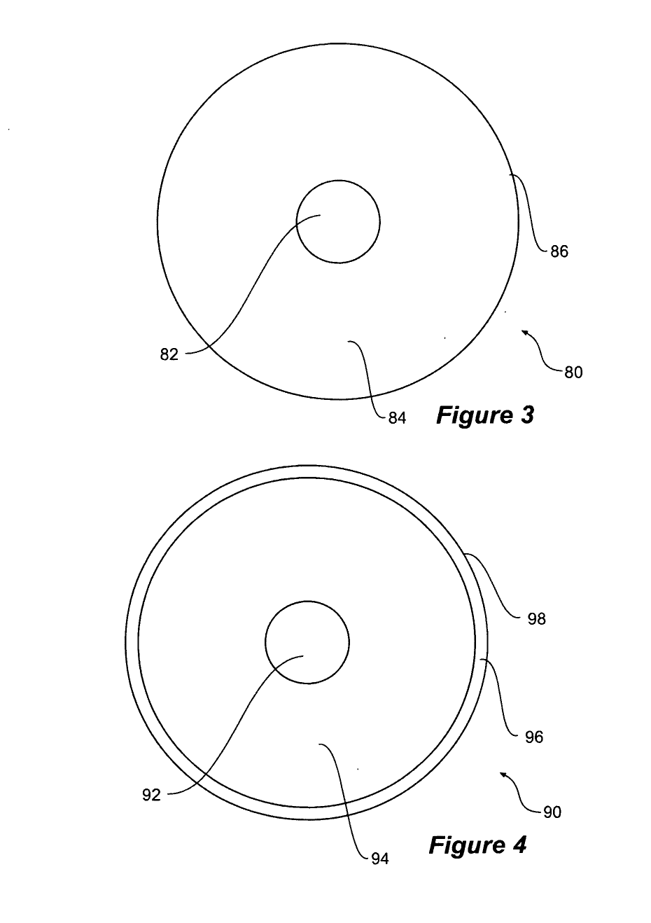

FIG. 3 shows a cross section of the embodiment of metering roller shown in FIG. 2. The metering roller 80 has an axle 82 and a cylindrical roller body 84 with a surface 86. The body 84 is made from a plastic material preferably polypropylene and injection moulded onto the axle 82. The overall diameter of the roller may be from 15 mm to 100 mm and a typical length of from 100 mm to 2 m.

FIG. 4 shows an alternative embodiment of metering roller according to the present invention. In this embodiment the metering roller 90 has an axle 92 and a cylindrical roller body 94 formed from a first plastic material with a layer of an alternative plastic material 96 over the layer 94 providing a surface 98 which has the recesses discussed above. The overall diameter of the roller may be from 15 mm to 100 mm and a typical length of from 100 mm to 2 m. The thickness of the alternative plastic material 96 may be from 2 mm to 10 mm. Hence the diameter of the cylindrical roller body 94 may be from 11 mm to 80 mm.

In this embodiment the material of the cylindrical body 94 can be of an electrically conductive material so that a voltage can be impressed upon the electrically conductive body which will give electrostatic assistance to application of a high viscosity ink onto the roller and transferred from the metering roller to a developing roller (not shown in FIG. 4).

Alternatively the axle 92 and the cylindrical roller body 94 may be formed from a metal such as steel with an annular layer of a plastic material 96 over the layer 94 providing a surface 98 which has the recesses discussed above. The overall diameter of the roller may be from 15 mm to 100 mm and a typical length of from 100 mm to 2 m. The thickness of the annular surface layer 96 may be from 2 mm to 10 mm. Hence the diameter of the metal cylindrical roller body 94 may be from 11 mm to 80 mm.

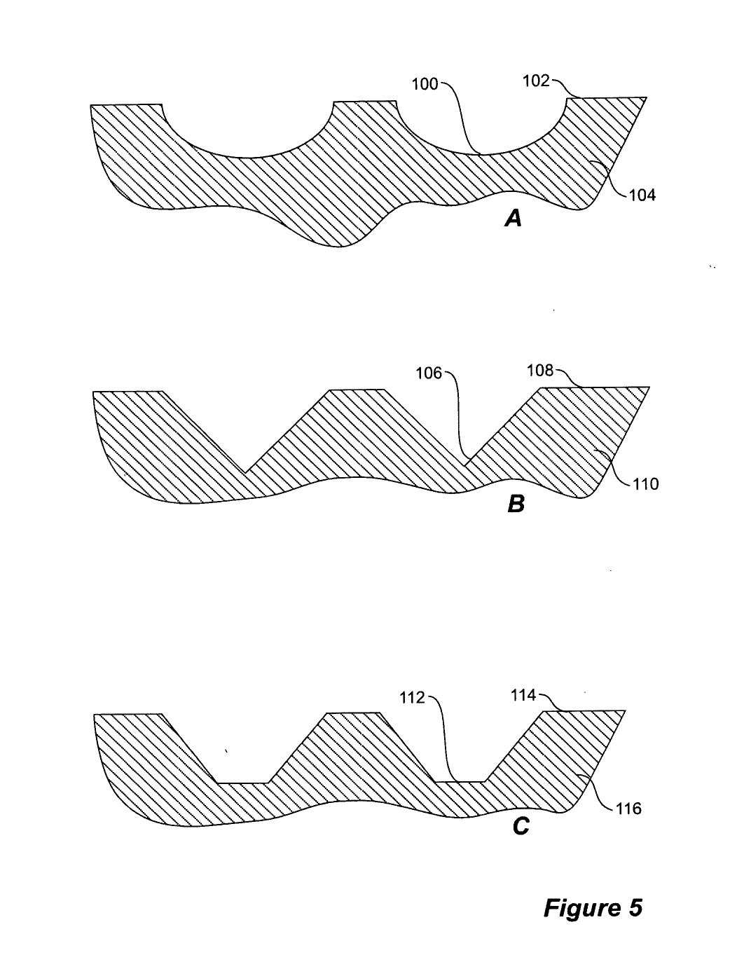

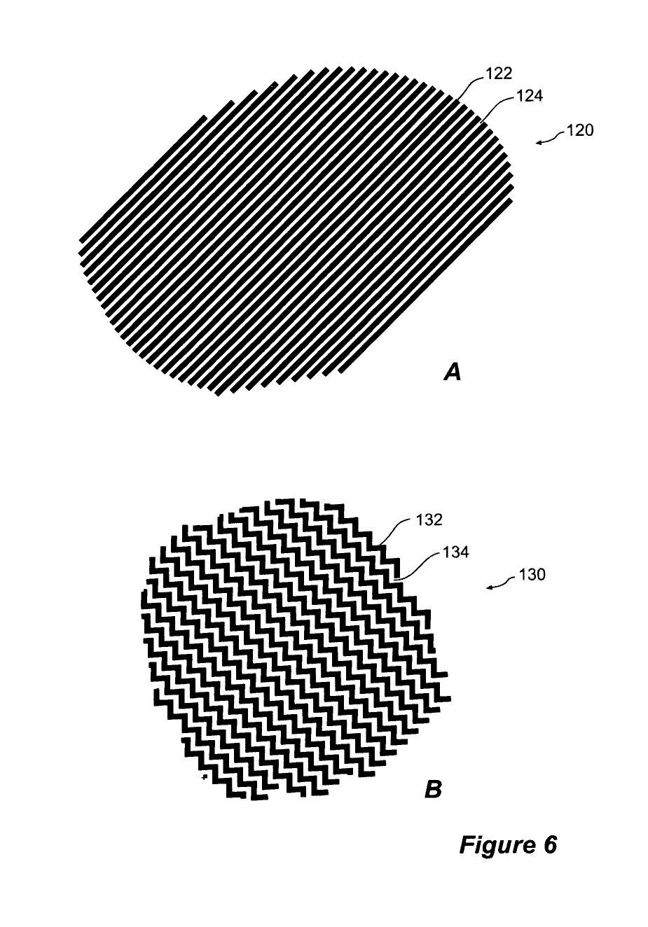

FIGS. 5A to 5C show various embodiments of surface pattern profile useful for the present invention and FIG. 6 shows a trihelical surface pattern.

FIG. 5A shows a semicircular profile 100 in the surface 102 of a surface layer 104 of a metering roller of one embodiment of the present invention. In this embodiment the semicircular recesses may have a depth of from 5 to 100 μm and a spacing of 0.003 to 0.01 inch (100 to 300 lines per inch).

FIG. 5B shows a triangular profile 106 in the surface 108 of a surface layer 110 of a metering roller of one embodiment of the present invention. In this embodiment the triangular recesses may have a depth of from 5 to 100 μm and a spacing of 0.003 to 0.01 inch (100 to 300 lines per inch).

FIG. 5C shows a trapezoidal profile 100 in the surface 102 of a surface layer 104 of a metering roller of one embodiment of the present invention. In this embodiment the trapezoidal recesses may have a depth of from 5 to 100 μm and a spacing of 0.003 to 0.01 inch (100 to 300 lines per inch).

Each of the semicircular, triangular or trapezoidal profiles shown in FIGS. 5A to C may be formed in the surface of the metering roller in a pattern selected from a random pattern, a trihelical or Z-channel arrangement.

FIGS. 6A and 6B show detail of a surface of a metering roller showing a close up of various surface patterns.

FIG. 6A shows a trihedral pattern formed by lands 122 and recesses 124 in a helical pattern on the surface 120 of the metering roller.

FIG. 6B shows a Z channel pattern formed by lands 132 and recesses 134 in a helical pattern on the surface 130 of the metering roller.

The surface energy of a plastic roller may be in the range of from 18 to 46 dynes/cm and the surface tension of a high viscosity ink may be in the range of from 20 to 30 dynes/cm. In contrast the surface energy of a prior art metal metering roller with a metal surface, for example a metal Anilox roller, is significantly higher, typically greater than 100 dynes/cm. The ink will therefore not fully wet the surface of the metering roller of the present invention as much as it would if the roller was metal. In contrast the surface energy of a prior art metal metering roller with a metal surface, for example a metal Anilox roller, is higher whereby the ink will wet the surface of the Anilox roller and require more energy to remove it at the stage of transfer to the development or inking roller.

The extremely good release properties of the toner from the cells of the plastic metering roller has allowed developing electrostatic latent images with viscous and highly concentrated liquid toner systems at high speed whilst achieving high print image density, no background staining or fog, and achieve highly resolved images, that are usually associated with analogue printing methods such as offset and gravure printing. Further, the use of plastic metering rollers has been shown to prevent irreversible cell contamination that has been associated with conventional metal Anilox rollers, and hence, extend the time between scheduled machine services.

In addition, the ability to apply reduced pressures between the development roller and the metering roller due to the fact that there is an increased toner transfer efficiency from the plastic metering roller to the development roller due to improved release properties of the plastic material, reduces the abrasion of the development roller and hence increases its service life.

It can be appreciated that changes to any of the above embodiments can be made without departing from the scope of the present invention as defined by the claims and that other variations of the specific construction disclosed herein can be made by those skilled in the art without departing from the invention.

1. A metering roller for a printing machine utilising a high viscosity ink, the metering roller comprising an axle and a cylindrical roller body formed on the axle, the cylindrical roller body comprising an annular surface layer, the annular surface layer having a surface of a low surface energy and a pattern formed in the annular surface layer, the pattern comprising a plurality of ink receiving recesses.

2. A metering roller as in claim 1 wherein the annular surface layer has a surface energy in the range of from 18 to 46 dynes/cm.

3. A metering roller as in claim 1 wherein the annular surface layer comprises a plastic material.

4. A metering roller as in claim 1 wherein the cylindrical roller body and the annular surface layer comprise a plastic material.

5. A metering roller as in claim 1 wherein the cylindrical roller body and the annular surface layer comprises the same plastic material.

6. A metering roller as in claim 5 wherein the cylindrical roller body and surface layer are integral and comprise an overall diameter of from 15 mm to 100 mm and a length of from 100 mm to 2 m.

7. A metering roller as in claim 1 wherein the cylindrical roller body and the annular surface layer comprise different plastic materials.

8. A metering roller as in claim 7 wherein the cylindrical roller body comprises a diameter of from 11 mm to 80 mm and the annular surface layer comprises a thickness of from 2 mm to 10 mm and the cylindrical roller body comprises a length of from 100 mm to 2 m

9. A metering roller as in claim 1 wherein the cylindrical roller body comprises metal and the annular surface layer comprises a plastic material.

10. A metering roller as in claim 9 wherein the annular surface layer comprises a thickness of from 2 mm to 10 mm.

11. A metering roller as in claim 1 wherein the pattern of the plurality of ink receiving recesses is selected from the group comprising a random, trihelical or Z-channel and having a line resolution of from 100 to 300 lines per inch and a pattern depth of from 5 to 100 μm or more preferably a tri-helical surface pattern configuration, a resolution of 200 lines per inch and a pattern depth of 30 μm.

12. A metering roller as in claim 11 wherein the pattern profile of the plurality of ink receiving recesses is selected from the group comprising semicircular, triangular or trapezoidal and more preferably a trapezoidal profile.

13. A metering roller as in claim 3 wherein the plastic material comprises a material selected from the group comprising polypropylene, polymethylpentene, polytetrafluoroethylene, acetal, polystyrene and nylon.

14. A metering roller as in claim 3 wherein the plastic material is insulative.

15. A metering roller as in claim 3 wherein the plastic material is electrically conductive.

16. A printing machine including a high viscosity ink supply mechanism to supply a high viscosity ink to a printing mechanism, the ink supply mechanism including a metering roller, the metering roller comprising an axle, a cylindrical roller body formed on the axle and an annular surface layer on the cylindrical roller body, the annular surface layer having a surface of a low surface energy substantially similar to the surface energy of the high viscosity ink and a pattern formed in the annular surface layer, the pattern comprising a plurality of ink receiving recesses.

17. A printing machine including a high viscosity ink supply mechanism to supply a high viscosity ink to a printing mechanism, the ink supply mechanism including a metering roller, the metering roller comprising an axle and a cylindrical roller body formed on the axle, the cylindrical roller body comprising a first plastic material and the cylindrical roller body comprising an annular surface layer of a second plastic material and a pattern formed in the annular surface layer, the pattern comprising a plurality of ink receiving recesses.

18. A printing machine as in claim 17 wherein the printing machine is an electrostatographic printing machine and the high viscosity ink comprises a high viscosity toner comprising a concentration of insoluble chargeable particles of up to 60% by weight in a non-conductive carrier liquid.

19. A printing machine as in claim 17 wherein the pattern of the plurality of ink receiving recesses is selected from the group comprising a random, trihelical or Z-channel and having a line resolution of from 100 to 300 lines per inch and a pattern depth of from 5 to 100 μm or more preferably a trihelical surface pattern configuration, a resolution of 200 lines per inch and a pattern depth of 30 μm.

20. A printing machine as in claim 19 wherein the pattern profile of the plurality of ink receiving recesses is selected from the group comprising semicircular, triangular or trapezoidal and more preferably a trapezoidal profile.

21. A printing machine as in claim 17 wherein the first plastic material comprises a material selected from the group comprising polypropylene, polymethylpentene, polytetrafluoroethylene, polystyrene, acetal and nylon and the second plastic material comprises a material selected from the group comprising polypropylene, polymethylpentene, polytetrafluoroethylene, acetal, polystyrene and nylon.

22. A printing machine as in claim 17 wherein the first plastic material and the second plastic material are both insulative.

23. A printing machine as in claim 17 wherein the first plastic material and the second plastic material are both electrically conductive.

24. A printing machine as in claim 17 wherein the second plastic material has an annular surface energy in the range of from 18 to 46 dynes/cm.

25. A printing machine as in claim 17 wherein the metering roller has a diameter of from 15 mm to 100 mm and a length of from 100 mm to 2 m.

26. A metering roller for a high viscosity ink supply mechanism, the metering roller comprising an axle and a cylindrical roller body formed on the axle and an annular surface on the cylindrical roller body, the cylindrical roller body comprising a plastic material selected from the group comprising polypropylene, polymethylpentene, polytetrafluoroethylene, polystyrene, acetal and nylon and a pattern formed in the annular surface, the pattern comprising a plurality of ink receiving recesses in a trihelical surface pattern with a trapezoidal profile configuration comprising a resolution of 200 lines per inch and a pattern depth of 30 μm and the cylindrical roller body comprising an overall diameter of from 15 mm to 100 mm and a length of from 100 mm to 2 m.

27. An electrostatic printing machine for high speed printing comprising;
(a) a toner supply device to supply to a toner supply roller a high viscosity highly concentrated toner;
(b) a metering roller which receives a thin layer of the toner from the toner supply roller;
(c) a development member;
(d) the metering roller bearing against the development member with an interference fit to transfer a thin layer of the toner onto the development member;
(e) an image forming stage, the image forming stage comprising an image carrying member having a surface adapted to retain an electrostatic latent image thereon;
(f) the development member engaging against the image carrying member with an interference fit to give a selected contact time therebetween;
(g) a development stage in which toner particles in the thin layer on the development member are transferred to the image carrying member under the influence of the electrostatic latent image on the image carrying member to provide a developed image thereon; and
(h) a transfer stage in which the developed image is transferred from the image carrying member onto a substrate,
wherein the metering roller comprises an axle and a cylindrical roller body formed on the axle, the cylindrical roller body comprising an annular surface layer, the annular surface layer having a surface of a low surface energy formed from a plastic material and a pattern formed in the annular surface layer, the pattern comprising a plurality of ink receiving recesses.

28. An electrostatic printing machine as in claim 27 further including a doctor blade bearing against the metering roller.

29. An electrostatic printing machine as in claim 27 wherein the pattern of the plurality of ink receiving recesses is selected from the group comprising a random, trihelical or Z-channel and having a line resolution of from 100 to 300 lines per inch and a pattern depth of from 5 to 100 μm or more preferably a trihelical surface pattern configuration, a resolution of 200 lines per inch and a pattern depth of 30 μm.

30. An electrostatic printing machine as in claim 27 wherein the pattern profile of the plurality of ink receiving recesses is selected from the group comprising semicircular, triangular or trapezoidal and more preferably a trapezoidal profile.
